(19) United States
(12) Patent Application Publication
(10) Pub. No.: US 2024/0340783 A1
(43) Pub. Date: Oct. 10, 2024

(54) SWITCHING CELL RESELECTION PARAMETERS

(71) Applicant: QUALCOMM Incorporated, San Diego, CA (US)

(72) Inventors: Prashant SHARMA, San Marcos, CA (US); Changhwan PARK, San Diego, CA (US); Bharat SHRESTHA, San Diego, CA (US)

(21) Appl. No.: 18/625,089

(22) Filed: Apr. 2, 2024

Related U.S. Application Data
(60) Provisional application No. 63/494,997, filed on Apr. 7, 2023.

(51) Int. Cl. H04W 48/18; H04W 48/08; H04W 84/06

(52) U.S. Cl. CPC H04W 48/18; H04W 48/08; H04W 84/06

(57) ABSTRACT

Various aspects of the present disclosure generally relate to wireless communication. In some aspects, a user equipment (UE) may receive first information relating to a first set of cell reselection parameters or a second set of cell reselection parameters, the first information including at least one of: second information indicating a location of one or more network entities, or third information indicating a selected set of cell reselection parameters of the first set of cell reselection parameters or the second set of cell reselection parameters. The UE may select the selected set of cell reselection parameters according to the first information. The UE may perform cell reselection according to the selected set of cell reselection parameters. Numerous other aspects are described.

### CROSS-REFERENCE TO RELATED APPLICATION

This Patent Application claims priority to U.S. Provisional Patent Application No. 63/494,997, filed on Apr. 7, 2023, entitled “SWITCHING CELL RESELECTION PARAMETERS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for switching cell reselection parameters.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

In some aspects, a method of wireless communication performed by a user equipment (UE) includes receiving first information relating to a first set of cell reselection parameters or a second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations; and performing cell reselection in association with the location of the one or more network entities or the particular set of cell reselection parameters.

In some aspects, a method of wireless communication performed by a network entity includes receiving capability information indicating whether a user equipment (UE) supports one or more of a first set of cell reselection parameters or a second set of cell reselection parameters; and transmitting first information relating to the first set of cell reselection parameters or the second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations.

In some aspects, an apparatus configured for wireless communication includes one or more memories comprising processor-executable instructions; and one or more processors configured to execute the processor-executable instructions and cause the apparatus to: receive first information relating to a first set of cell reselection parameters or a second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations; and perform cell reselection in association with the location of the one or more network entities or the particular set of cell reselection parameters.

In some aspects, an apparatus configured for wireless communication includes one or more memories comprising processor-executable instructions; and one or more processors configured to execute the processor-executable instructions and cause the apparatus to: receive capability information indicating whether a user equipment (UE) supports one or more of a first set of cell reselection parameters or a second set of cell reselection parameters; and transmit first information relating to the first set of cell reselection parameters or the second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations.

Other aspects provide: an apparatus operable, configured, or otherwise adapted to perform any one or more of the aforementioned methods and/or those described herein with reference to and as illustrated by the drawings; a non-transitory, computer-readable medium comprising computer-executable instructions that, when executed by a processor of an apparatus, cause the apparatus to perform the aforementioned methods and/or those described herein with reference to and as illustrated by the drawings; a computer program product embodied on a computer-readable storage medium comprising code for performing the aforementioned methods and/or those described herein with reference to and as illustrated by the drawings; and/or an apparatus comprising means for performing the aforementioned methods and/or those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated, by way of example, in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with aspects of the present disclosure.

FIG. 2 depicts aspects of an example base station (BS) and user equipment (UE), in accordance with aspects of the present disclosure.

FIG. 3 depicts an example disaggregated base station architecture, in accordance with aspects of the present disclosure.

FIGS. 4A-4D depict aspects of data structures for a wireless communications network, in accordance with aspects of the present disclosure.

FIG. 5 is a diagram illustrating an example of cells of an air-to-ground (ATG) network deployment, in accordance with aspects of the present disclosure.

FIG. 6 is a diagram illustrating an example of signaling for selecting a set of cell reselection parameters, in accordance with aspects of the present disclosure.

FIG. 7 shows a method for wireless communications by a UE, in accordance with aspects of the present disclosure.

FIG. 8 shows a method for wireless communications by a network entity, in accordance with aspects of the present disclosure.

FIG. 9 is a diagram illustrating an example of an implementation of code and circuitry for a communications device, in accordance with aspects of the present disclosure.

FIG. 10 is a diagram illustrating an example of an implementation of code and circuitry for a communications device, in accordance with aspects of the present disclosure.

### DETAILED DESCRIPTION

Aspects of the present disclosure provide apparatuses, methods, processing systems, and computer-readable mediums for switching cell reselection parameters.

After powering on or entering an idle or inactive mode, a user equipment (UE) may select a cell on which to camp. Camping involves silently monitoring periodic broadcasting of signals, such as system information blocks (SIBs) and synchronization signal blocks (SSBs), without a network node associated with the cell being aware of the camping UE. “Camping” on a cell or network node may refer to a UE monitoring broadcasts from a cell (for example, monitoring a control channel associated with the cell or the network node) to maintain readiness to actively connect with the cell or network node and utilize the wireless communication system. Upon or before leaving the coverage area of a cell, a camped UE may perform cell reselection to identify another suitable cell on which to camp, which may involve periodic measurement of neighbor cells and identification of a suitable neighbor cell according to the measurements. The UE may perform cell reselection according to a set of cell reselection parameters, described elsewhere herein.

Air-to-ground (ATG) networks are being explored to improve cellular coverage for aircraft. In an ATG network deployment, cells are provided by network nodes on the ground. Antennas of the network nodes may be directed upward toward aircraft. UEs associated with an ATG network, such as a Customer Premises Equipment (CPE) type UE mounted to an aircraft, may camp on or connect to the ATG network. Example bands for an ATG network include bands n1, n78, and n79. The cell size of an ATG network may vary significantly due to variation in inter-site distance (ISD), such as in a range of approximately 14 to approximately 200 km. Furthermore, UEs associated with an ATG network may be associated with a high travel speed, for example, 1200 km/h. Therefore, the dwell time of an ATG UE (e.g., the time in which the ATG UE is camped on a given cell or in a coverage area of the given cell) may be short, particularly for a smaller cell. In such situations, cell reselection parameters that are suitable for other network deployments, such as traditional terrestrial network deployments with downward-facing antennas, may not be suitable for ATG UEs, particularly in smaller cells. However, there are situations in which cell reselection parameters that are suitable for traditional terrestrial network deployments are suitable for ATG UEs. If the ATG UE uses only cell reselection parameters of a traditional terrestrial network (defined elsewhere herein), then the ATG UE may fail to reselect quickly enough in a small ATG cell. However, if the ATG UE uses only cell reselection parameters suitable for a small ATG cell, then the UE may expend measurement resources and reduce throughput performing frequent measurement, which may not be necessary in a larger cell.

Various aspects relate generally to cell reselection. Some aspects more specifically relate to cell reselection for different cell sizes, such as in an ATG network. In some examples, a UE may select a set of cell reselection parameters from a first set of cell reselection parameters and a second set of cell reselection parameters, and may perform cell reselection according to the set of cell reselection parameters. For example, the UE may select the set of cell reselection parameters according to information indicating the selected set of cell reselection parameters. As another example, the UE may select the set of cell reselection parameters based at least in part on information indicating a location of one or more network entities. In some aspects, the selection of the set of cell reselection parameters may be based at least in part on an altitude or speed or dwell time of the UE.

Particular aspects of the subject matter described in this disclosure can be implemented to realize one or more of the following potential advantages. In some examples, by selecting a set of cell reselection parameters from a first set of cell reselection parameters and a second set of cell reselection parameters, the described techniques can be used to improve the suitability of cell reselection parameters in view of how long a UE is expected to camp on a cell. By selecting the set of cell reselection parameters according to information indicating the selected set of cell reselection parameters, UE processing load may be reduced and overhead at the network may be reduced relative to signaling information indicating locations of network entities implementing cells. By selecting the set of cell reselection parameters based at least in part on information indicating a location of one or more network entities, processing load at the network may be reduced. By selecting the set of cell reselection parameters based at least in part on an altitude or dwell time of the UE, the suitability of cell reselection parameters can be further improved by taking into account the effect of altitude or speed on how long a UE is expected to be covered by a cell.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

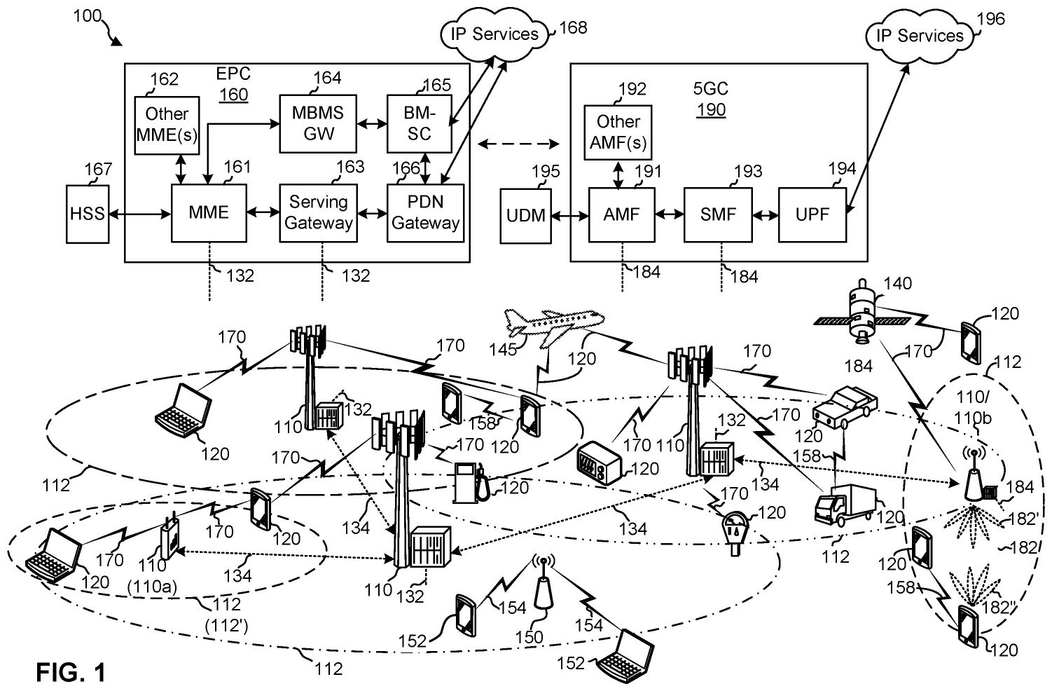

FIG. 1 depicts an example of a wireless communications network 100, in accordance with aspects of the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device, an always on (AON) device, an edge processing device, a CPE, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

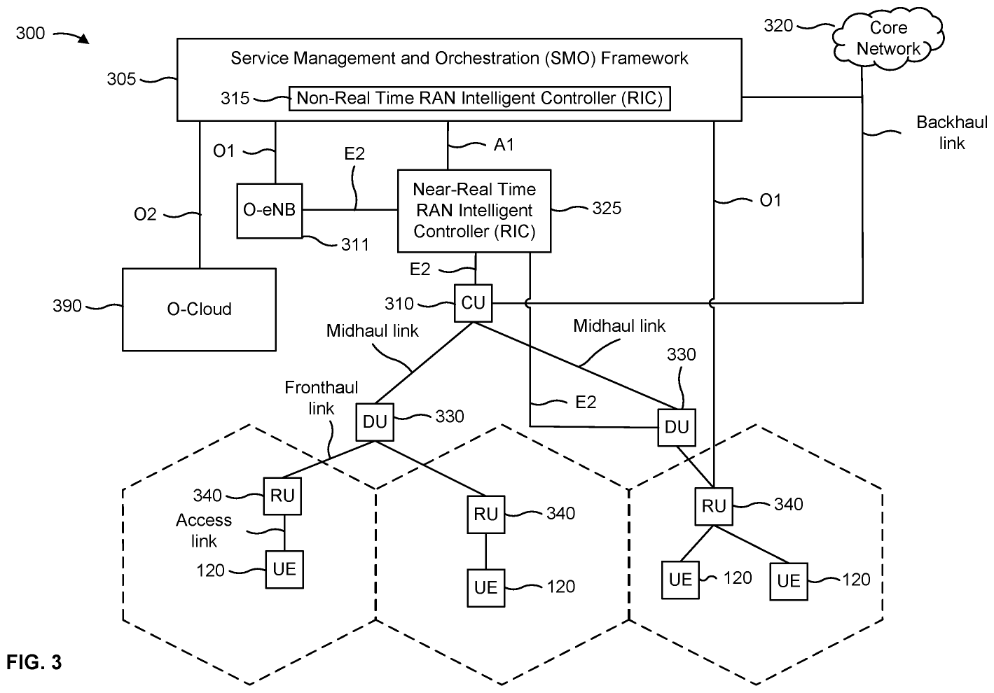

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mmWave or near mmWave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

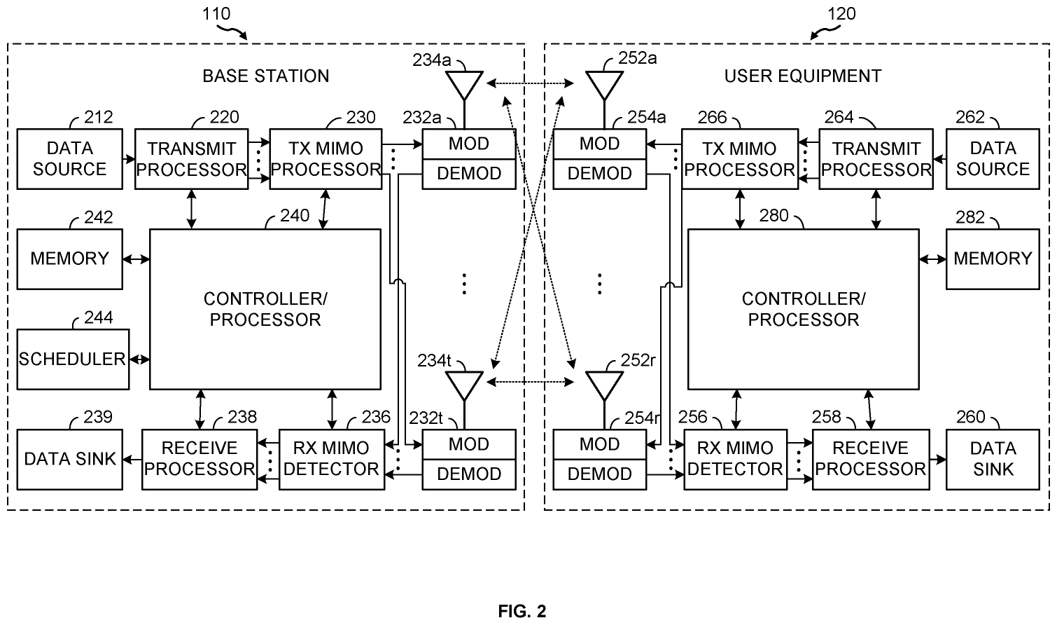

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an O-RAN (such as the network configuration sponsored by the O-RAN Alliance), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as Al policies).

As indicated above, FIG. 3 is provided as an example. Other examples may differ from what is described with regard to FIG. 3.

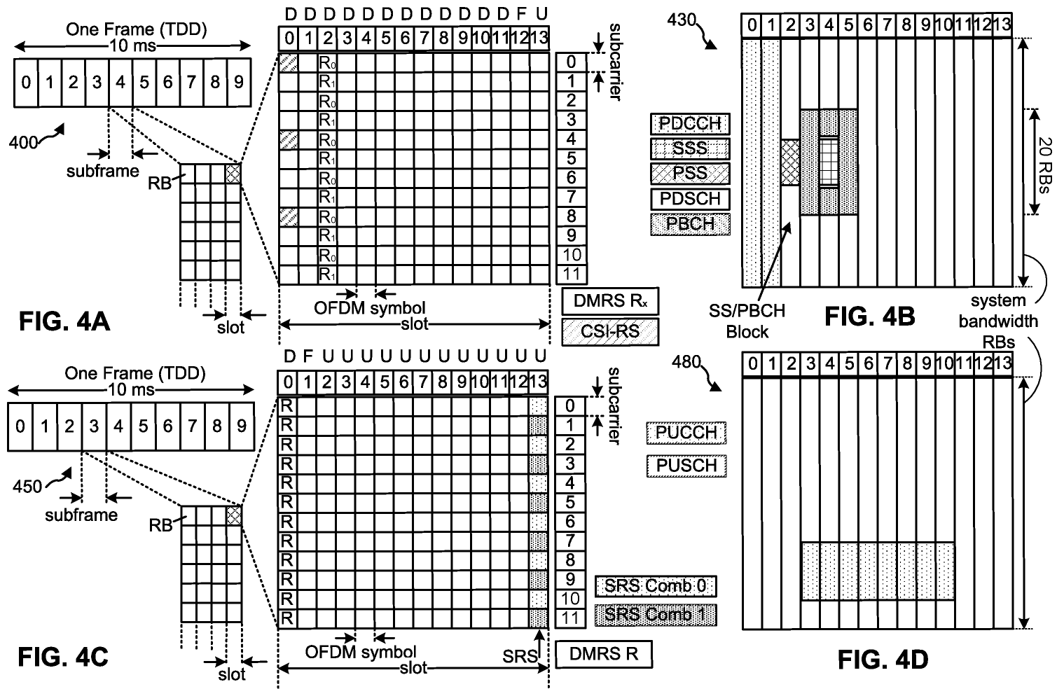

FIGS. 4A, 4B, 4C, and 4D depict aspects of data structures for a wireless communications network, such as wireless communications network 100 of FIG. 1, in accordance with aspects of the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing. OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SSB). The MIB provides a number of RBs in the system bandwidth and a system frame number (SFN). The PDSCH carries user data, broadcast system information not transmitted through the PBCH such as SIBs, and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment/negative acknowledgement (ACK/NACK) feedback. The PUSCH carries data, and may additionally be used to carry a buffer status report (BSR), a power headroom report (PHR), and/or UCI.

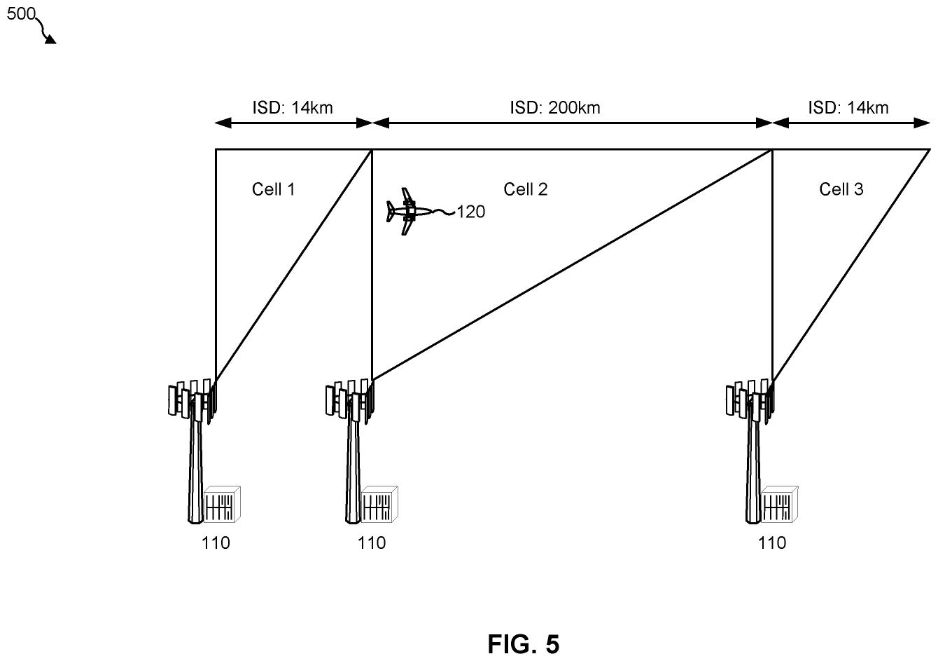

FIG. 5 is a diagram illustrating an example 500 of cells of an ATG network deployment, in accordance with aspects of the present disclosure. Example 500 includes a first cell (Cell 1), a second cell (Cell 2), and a third cell (Cell 3). It can be seen that the size of a cell is generally related to the ISD between network entities (e.g., base station 110) implementing the cells. For example, Cell 2 is larger than Cell 1 or Cell 3, corresponding to an ISD of 200 km. Cell 1 and Cell 3 each have ISDs of 14 km.

A UE, such as an ATG UE, may camp on a cell (e.g., the first cell, the second cell, or the third cell). As the UE moves from one cell to another, the UE may perform cell reselection to identify another suitable cell on which to camp. Cell reselection may include measurements according to a set of cell reselection parameters. Techniques described herein may relate to a first set of cell reselection parameters and a second set of cell reselection parameters, wherein the first set of cell reselection parameters is at least partially different than the second set of cell reselection parameters. In some examples, the first set of cell reselection parameters may be associated with a baseline (e.g., terrestrial, legacy) network and the second set of cell reselection parameters may be associated with a high-speed train (HST) network. For example, the first set of cell reselection parameters may be based at least in part on Table 1, below.

TABLE 1

| Discontinuous | | | | T_{detect, NR}_{_{—}}_{Intra} [s] | T_{measure, NR}_{_{—}}_{Intra} [s] | T_{evaluate, NR}_{_{—}}_{Intra} [s] |
|---|---|---|---|---|---|---|
| Reception (DRX) | Scaling Factor (N1) | | | (number of | (number of | (number of |
| cycle length [s] | FR1 | FR2-1 | FR2-2 | DRX cycles) | DRX cycles) | DRX cycles) |
| 0.32 | 1 | 8 | 12 | 11.52 × N1 × | 1.28 × N1 × M2 | 5.12 × N1 × M2 |
| | | | | M2 (36 × N1 × M2) | (4 × N1 × M2) | (16 × N1 × M2) |
| 0.64 | | 5 | 8 | 17.92 × N1 | 1.28 × N1 | 5.12 × N1 |
| | | | | (28 × N1) | (2 × N1) | (8 × N1) |
| 1.28 | | 4 | 6 | 32 × N1 | 1.28 × N1 | 6.4 × N1 |
| | | | | (25 × N1) | (1 × N1) | (5 × N1) |
| 2.56 | | 3 | 5 | 58.88 × N1 | 2.56 × N1 | 7.68 × N1 |
| | | | | (23 × N1) | (1 × N1) | (3 × N1) |

As mentioned above, Table 1 provides just one example of the first set of cell reselection parameters, and the first set of cell reselection parameters may be different than those described above in some implementations. For example, the first set of cell-reselection parameters may include a T_{detect} value (referred to as a detection time duration) for an inter-frequency measurement. In Table 1, M2=1.5 if SMTC periodicity of measured intra-frequency cell >20 ms; otherwise M2=1. If different SSB-based radio resource management Measurement Timing Configuration (SMTC) periodicities are configured for different cells, the SMTC periodicity in this note is the one used by the cell being identified. During primary or secondary synchronization signal (PSS/SSS) detection, the periodicity of the SMTC configured for the intra-frequency carrier is assumed, and if the actual SSB transmission periodicity is greater than the SMTC configured for the intra-frequency carrier, longer T_{detect, NR_intra} is expected.

The second set of cell reselection parameters may be based at least in part on Table 2, below.

TABLE 2

| DRX | | | |
|---|---|---|---|
| cycle | T_{detect, NR}_{_{—}}_{Intra} [S] | T_{measure, NR}_{_{—}}_{Intra} [s] | T_{evaluate, NR}_{_{—}}_{Intra} [s] |
| length | (number of DRX | (number of DRX | (number of DRX |
| [s] | cycles) | cycles) | cycles) |
| 0.32 | 2.56 × M2 (8 × M2) | 0.32 × M3 (1 × M3) | 0.96 × M4 (3 × M4) |
| 0.64 | 5.12 (8) | 0.64 (1) | 1.92 (3) |
| 1.28 | 8.96 (7) | 1.28 (1) | 3.84 (3) |
| 2.56 | 58.88 (23) | 2.56 (1) | 7.68 (3) |

As mentioned above, Table 2 provides just one example of the second set of cell reselection parameters, and the second set of cell reselection parameters may be different than those described above in some implementations. For example, the second set of cell-reselection parameters may include a T_{detect} value (referred to as a detection time duration) for an inter-frequency measurement. When an SMTC<=40 ms, M2=M3=M4=1; and when SMTC>40 ms, M2=1.5, M3=M4=2. In some aspects, the second set of cell reselection parameters shown by Table 2 may be associated with ATG cells. For example, the second set of cell reselection parameters may be specific to ATG cells (e.g., of smaller than a threshold size) or may be different than a set of cell reselection parameters that are not specific to ATG cells (such as Table 1's cell reselection parameters).

The UE may identify new intra-frequency cells and perform synchronization signal reference signal received power (SS-RSRP) and synchronization signal reference signal received quality (SS-RSRQ) measurements of the identified intra-frequency cells without an explicit intra-frequency neighbor list containing physical layer cell identities. The UE may evaluate whether a newly detectable intra-frequency cell meets reselection criteria (e.g., as specified in a wireless communication specification) within a detection time duration referred to as T_{detect,NR_Intra} when that T_{reselection}=0. In some aspects, the UE may evaluate whether a newly detectable intra-frequency cell meets reselection criteria (e.g., as specified in a wireless communication specification) within a detection time duration referred to as T_{detect} when that T_{reselection}=0. The UE may measure SS-RSRP and SS-RSRQ at least every T_{measure,NR_Intra} for intra-frequency cells that are identified and measured according to the measurement rules. The UE may filter SS-RSRP and SS-RSRQ measurements of each measured intra-frequency cell using at least 2 measurements. Within the set of measurements used for the filtering, at least two measurements may be spaced by at least T_{measure,NR_Intra}/2. The UE may not consider a NR neighbor cell in cell reselection, if it is indicated as not allowed in the measurement control system information of the serving cell. For an intra-frequency cell that has been already detected, but that has not been reselected to, the filtering shall be such that the UE shall be capable of evaluating that the intra-frequency cell has met reselection criterion within T_{evaluate,NR_Intra} when T_{reselection}=0. T_{detect,NR_Intra}, T_{measure,NR_Intra}, and T_{evaluate,NR_Intra} may be referred to herein as time durations, and may relate to intra-frequency measurement. Another set of time durations T_{detect}, Tₘₑₐₛᵤᵣₑ, and/or Tₑᵥₐₗᵤₐₜₑ may be used for inter-frequency measurement. “Time duration,” as used herein, can refer to a time duration for inter-frequency measurement or a time duration for intra-frequency measurement. For example, the detection time duration “T_{detect}” can refer to T_{detect} for inter-frequency reselection or to T_{detect} for intra-frequency reselection. For example, the measurement time duration “Tₘₑₐₛᵤᵣₑ” can refer to Tₘₑₐₛᵤᵣₑ for inter-frequency reselection or to Tₘₑₐₛᵤᵣₑ for intra-frequency reselection. For example, the evaluation time duration “Tₑᵥₐₗᵤₐₜₑ” can refer to Tₑᵥₐₗᵤₐₜₑ for inter-frequency reselection or to Tₑᵥₐₗᵤₐₜₑ for intra-frequency reselection.

Techniques described herein may provide selecting from the first set of cell reselection parameters or the second set of cell reselection parameters, such as according to network signaling, a configured threshold, locations of cells, or the like. For example, the first set of cell reselection parameters and the second set of cell reselection parameters may be alternative to each other, meaning that the UE may perform cell selection using only one of the first set of cell reselection parameters or the second set of cell reselection parameters.

As indicated above, FIG. 5 is provided as an example. Other examples may differ from what is described with regard to FIG. 5.

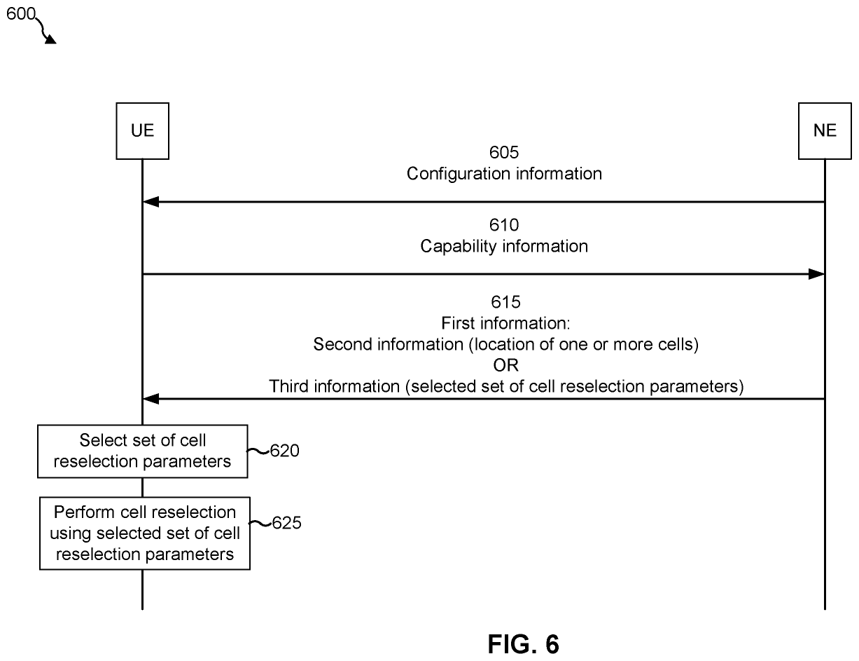

FIG. 6 is a diagram illustrating an example 600 of signaling for selecting a set of cell reselection parameters, in accordance with aspects of the present disclosure. As shown, example 600 includes a UE (e.g., UE 120) and a network entity (e.g., BS 110, a component of a disaggregated base station described with regard to FIG. 3). In some aspects, the UE may be an ATG UE (such as a UE associated with an ATG network flag, a UE associated with an ATG network, a UE mounted to an aircraft, or the like). In some aspects, the network entity may be associated with an ATG network. For example, the network entity may implement one or more ATG cells, such as the first cell, the second cell, or the third cell of FIG. 5. In example 600, the UE may be in an idle mode, and may be camped on a cell (e.g., an ATG cell).

As shown in FIG. 6, and by reference number 605, the network entity may transmit, and the UE may receive, configuration information. The network entity may transmit the configuration information via any suitable form of signaling, such as RRC signaling, DCI, system information (S1) (e.g., an SIB), or the like.

In some aspects, the configuration information may define or relate to a threshold. For example, the threshold may be based at least in part on a serving cell size of a serving cell of the UE. As another example, the threshold may be based at least in part on an elevation angle between the UE and a serving cell of the UE. Each is described in more detail below.

In some aspects, the threshold may be based at least in part on a serving cell size of a serving cell of the UE. For example, the threshold may indicate a threshold serving cell size. If a serving cell size of the serving cell of the UE fails to satisfy the threshold (e.g., is less than the threshold, is less than or equal to the threshold), then the UE may use a second set of cell reselection parameters, such as, for example, a set of cell reselection parameters associated with a HST network. If the serving cell size of the serving cell of the UE satisfies the threshold (e.g., is greater than the threshold, is greater than or equal to the threshold), then the UE may use a first set of cell reselection parameters, such as, for example, a set of cell reselection parameters associated with a baseline network. Thus, the threshold may be based at least in part on the serving cell size. The UE may determine the serving cell size, for example, by estimating the ISD based on network entity locations, and may deduce the serving cell size considering an altitude of the UE.

In some aspects, the threshold may be based at least in part on a dwell time of the UE in a particular cell. For example, the threshold may indicate a threshold dwell time for a cell. If an estimated dwell time of the UE in the serving cell fails to satisfy the threshold (e.g., is less than the threshold, is less than or equal to the threshold), then the UE may use the second set of cell reselection parameters. If the estimated dwell time of the UE in the serving cell satisfies the threshold (e.g., is greater than the threshold, is greater than or equal to the threshold), then the UE may use the first set of cell reselection parameters. The UE may determine its dwell time in the serving cell, for example, by dividing the serving cell size by a speed of the UE. The UE may determine the serving cell size, for example, by estimating the ISD based on network entity locations, and may deduce the serving cell size considering an altitude of the UE.

In some aspects, the threshold may be based at least in part on a reference point (such as a location of a network entity, which may be indicated to the UE via second information described below) and/or a distance to a cell boundary. For example, the threshold may be based at least in part on a ratio of a distance from the UE to a reference point and a distance of the UE to a cell boundary. If the ratio fails to satisfy the threshold (e.g., is less than the threshold, is less than or equal to the threshold), then the UE may use the first set of cell reselection parameters. If the ratio satisfies the threshold (e.g., is greater than the threshold, is greater than or equal to the threshold), then the UE may use the second set of cell reselection parameters.

In some aspects, the threshold may be based at least in part on an altitude of the UE or a speed of the UE. For example, UEs flying at a lower altitude (e.g., 3 km) may have a lower threshold while UEs flying at a higher altitude (e.g., 10 km) may have a higher threshold. As another example, UEs flying at a lower speed (e.g., during take-off and landing) may have a lower threshold and UEs flying at a higher speed may have a higher threshold.

In some aspects, the threshold may be based at least in part on an elevation angle (Φ) between the UE and a serving cell of the UE. The elevation angle may be between a horizontal plane and a line connecting the UE and a network entity (e.g., a network entity implementing the serving cell). The UE may determine the elevation angle using positioning information of the UE (e.g., as estimated by a global navigation satellite system), an altitude of the UE, and a location of the network entity. In some aspects, the threshold may be based at least in part on a minimum elevation angle (⊖), which may be indicated by second information (described below) or S1 of the serving cell (e.g., the configuration information shown by reference number 605 or other information). The minimum elevation angle may indicate a lowest angle (between the horizontal plane and the line connecting the UE and the network entity) at which the cell is viable. For example, the minimum elevation angle may indicate a cell boundary of the cell in angular terms. The UE may determine the selected set of cell reselection parameters based at least in part on the minimum elevation angle. For example, if a difference between the elevation angle and the minimum elevation angle (Φ minus ⊖) satisfies a threshold X (e.g., is greater than the threshold, is greater than or equal to the threshold), the UE may select the first set of cell reselection parameters. If the difference between the elevation angle and the minimum elevation angle (Φ minus ⊖) fails to satisfy a threshold X (e.g., is less than the threshold, is less than or equal to the threshold), the UE may select the second set of cell reselection parameters.

In some aspects, the threshold may be based at least in part on a rate of change associated with the elevation angle. The rate of change may be defined as (Φ minus ⊖) divided by a speed of the UE or as a (Φ minus ⊖) divided by a speed of the UE at a given altitude (referred to as a normalized elevation angle of the UE). If the rate of change satisfies the threshold (e.g., is less than the threshold, is less than or equal to the threshold), then the UE may select the second set of cell reselection parameters. If the 0097-4696 27 rate of change does not satisfy the threshold (e.g., is greater than the threshold, is greater than or equal to the threshold), then the UE may select the first set of cell reselection parameters. As described above, the threshold that is based at least in part on the elevation angle may be further based at least in part on a speed of the UE and/or an altitude of the UE.

In some aspects, the configuration may indicate a reference speed. Additionally, or alternatively, the configuration may indicate a reference altitude. A reference speed and/or reference altitude may be used as a threshold to determine whether a set of cell reselection parameters applies. Additionally, or alternatively, a reference speed and/or reference altitude may be used to determine or modify a threshold. For example, the UE may determine whether an indicated set of cell reselection parameters applies according to the reference speed and/or the reference altitude. More particularly, if a speed of the UE is below the reference speed, the UE may use the first set of cell reselection parameters. As another example, if an altitude of the UE is below the reference altitude, the UE may use the first set of cell reselection parameters. Otherwise (e.g., if the speed and/or the altitude is above the reference speed and/or the reference altitude), the UE may apply an indicated set of cell reselection parameters. Thus, the reference speed and/or the reference altitude may selectively override an indicated set of cell reselection parameters. In this way, the UE identifies the selected set of cell reselection parameters according to a signaled selected set of cell reselection parameters (e.g., via third information, described below) and based at least in part on a threshold, associated with the reference speed or the reference altitude, being satisfied. In some aspects, the reference speed or the reference altitude may be specified in a wireless communication specification.

As shown by reference number 610, the UE may transmit, and the network entity may receive, capability information. The capability information may indicate whether the UE supports one or more of the first set of cell reselection parameters or the second set of cell reselection parameters. For example, the UE may support only the first set of cell reselection parameters. As another example, the UE may support both the first set of cell reselection parameters and the second set of cell reselection parameters. As another example, the UE may indicate one or more supported sets of cell reselection parameters from multiple sets of cell reselection parameters. The UE and the network entity may perform one or more operations of example 600 in accordance with the capability information, such as the signaling of configuration information of reference number 605, the transmission and reception of the first information of reference number 615, or the cell reselection of reference number 620. For example, the UE or the network entity may select a set of cell reselection parameters from the set(s) of cell reselection parameters indicated by the capability information as supported by the UE. As another example, the configuration information of reference number 605 may indicate only cell reselection parameters supported by the UE.

As shown by reference number 615, the network entity may transmit, and the UE may receive, first information. The network entity may transmit the first information via any suitable form of signaling, such as RRC signaling, DCI, S1 (e.g., a SIB), or the like. In some aspects, the first information may include the configuration information described with regard to reference number 605 (that is, the configuration information may comprise or be included in the first information, instead of being transmitted separately from the first information). In some aspects, the configuration information described with regard to reference number 605 may include the first information. The first information may relate to the first set of cell reselection parameters or the second set of cell reselection parameters in that the first information may indicate a selected set of cell reselection parameters or information used to select the selected set of cell reselection parameters.

In some aspects, the first information may include third information. The third information may indicate a selected set of cell reselection parameters. The selected set of cell reselection parameters may correspond to a serving cell. For example, for each cell, the network entity may transmit (e.g., broadcast, via S1 of the cell) information indicating a selected set of cell reselection parameters. When the UE camps on a cell, the UE may apply the selected set of cell reselection parameters for the cell (in some examples, subject to a threshold such as the reference altitude or the reference speed described above), such as by performing measurements or other cell reselection operations in accordance with the selected set of cell reselection parameters. In some aspects, the third information may comprise a bit. For example, a first value of the bit may indicate to use the first set of cell reselection parameters and a second value of the bit may indicate to use the second set of cell reselection parameters.

In some aspects, the first information may include second information. The second information may indicate a location of one or more network entities. For example, the network entity may indicate a location of a network entity implementing a serving cell of the UE and/or one or more network entities implementing one or more neighbor cells of the UE. In some aspects, the network entity may transmit the second information via S1 such as SIB 19 for a given cell. For example, SIB 19 transmitted on the given cell may indicate a location of a network entity implementing the given cell and/or locations of one or more network entities implementing neighbor cells of the given cell. In some aspects, the second information may include information indicating a serving cell size, a serving cell radius, or the like.

As shown by reference number 620, the UE may select a set of cell reselection parameters, of the first set of cell reselection parameters or the second set of cell reselection parameters. For example, the UE may use a selected set of cell reselection parameters indicated by the third information (e.g., subject to a threshold such as the reference altitude or the reference speed described above). As another example, the UE may select the selected set of cell reselection parameters according to a threshold, such as a threshold based at least in part on an elevation angle of the UE or a threshold based at least in part on a cell size of a serving cell of the UE (described in connection with reference number 605, above). For example, the UE may determine a location of the UE (such as using a global navigation satellite system). The UE may use the location of the UE, in conjunction with one or more threshold described with regard to reference number 605 above, to select the set of cell reselection parameters.

As shown by reference number 625, the UE may perform cell reselection according to the selected set of cell reselection parameters. For example, the UE may perform measurements according to one or more parameters (e.g., a time duration such as T_{detect}, Tₘₑₐₛᵤᵣₑ, Tₑᵥₐₗᵤₐₜₑ, or the like) of the selected set of cell reselection parameters. As another example, as described above, the UE may evaluate whether a newly detectable inter-frequency cell meets reselection criteria (e.g., as specified in a wireless communication specification) within the time duration T_{detect}. By performing cell reselection according to the selected set of cell reselection parameters (such as by evaluating the newly detectable inter-frequency cell within the time duration), the UE evaluates cells for camping according to a set of cell reselection parameters that is appropriate for an ATG cell or a terrestrial cell. Furthermore, by selecting the cell reselection parameters according to the first information and/or the third information, processing load at the network may be reduced. For example, the UE may use cell reselection parameters that facilitate quick reselection in a small ATG cell, or may use a set of cell reselection parameters associated with a larger cell, thereby efficiently using measurement resources and improving throughput by performing less frequent measurement.

As indicated above, FIG. 6 is provided as an example. Other examples may differ from what is described with regard to FIG. 6.

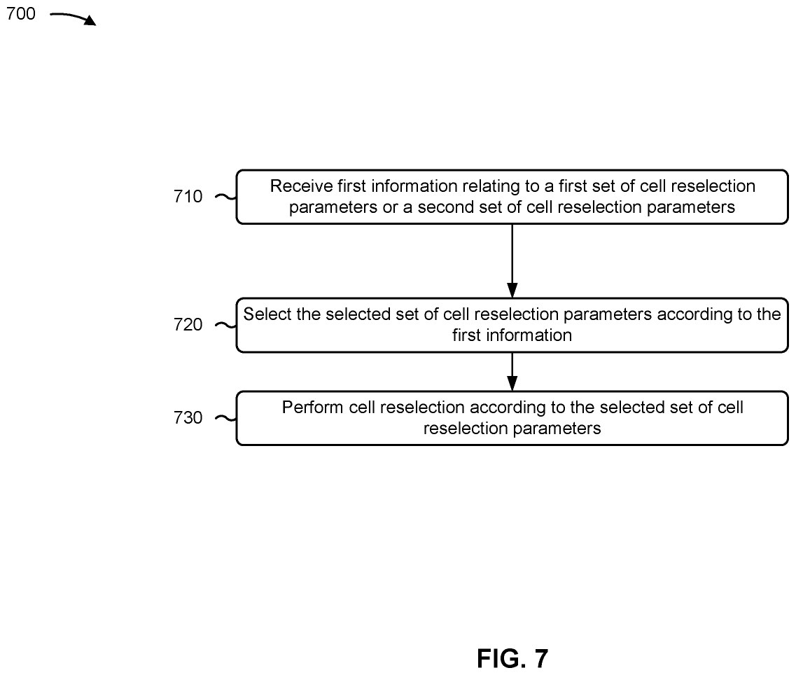

FIG. 7 shows a method 700 for wireless communications by a UE, such as UE 120, in accordance with aspects of the present disclosure.

Method 700 begins at 710 with receiving first information relating to a first set of cell reselection parameters or a second set of cell reselection parameters. The first information may include at least one of second information indicating a location of one or more network entities, or third information indicating a particular set of cell reselection parameters, of the first set of cell reselection parameters or the second set of cell reselection parameters. In some aspects, the second information may relate to the first set of cell reselection parameters or the second set of cell reselection parameters. For example, the location may be used to select a set of parameters, of the first set of parameters or the second set of parameters. In some aspects, the third information may relate to the first set of parameters or the second set of parameters. For example, the third information may indicate a particular set of parameters associated with air-to-ground (ATG) cells, of the first set of parameters or the second set of parameters, which the UE may use for cell reselection.

Method 700 then proceeds to step 720 with selecting a specified set of cell reselection parameters according to the first information.

Method 700 then proceeds to step 730 with performing cell reselection according to the selected set of cell reselection parameters. In some aspects, the UE may perform cell reselection in association with the location of the one or more network entities (such as by selecting the selected set of cell reselection parameters according to the location) or the particular set of cell reselection parameters (such as by performing cell reselection using the particular set of cell reselection parameters).

Method 700 may include additional aspects, such as any single aspect or any combination of aspects described below and/or in connection with one or more other processes described elsewhere herein.

In a first aspect, the first information includes the second information.

In a second aspect, alone or in combination with the first aspect, selecting the specified set of cell reselection parameters further comprises selecting the specified set of cell reselection parameters in accordance with a threshold for the second information.

In a third aspect, alone or in combination with one or more of the first and second aspects, the threshold is a threshold serving cell size of a serving cell of the UE.

In a fourth aspect, alone or in combination with one or more of the first through third aspects, method 700 includes determining a serving cell size in accordance with the second information, wherein selecting the specified set of cell reselection parameters in accordance with the threshold further comprises selecting the specified set of cell reselection parameters by comparing the serving cell size and the threshold serving cell size.

In a fifth aspect, alone or in combination with one or more of the first through fourth aspects, the threshold is further based at least in part on at least one of a speed of the UE, a dwell time of the UE, an altitude of the UE, or a distance from a reference point to a cell boundary of the serving cell of the UE.

In a sixth aspect, alone or in combination with one or more of the first through fifth aspects, method 700 includes receiving fourth information indicating the threshold. In some aspects, the fourth information may indicate a set of cell reselection parameters to be selected if the threshold is satisfied and/or another set of cell reselection parameters to be selected if the threshold is not satisfied.

In a seventh aspect, alone or in combination with one or more of the first through sixth aspects, the threshold is based at least in part on an elevation angle between the UE and a serving cell of the UE.

In an eighth aspect, alone or in combination with one or more of the first through seventh aspects, method 700 includes determining the elevation angle in accordance with the second information.

In a ninth aspect, alone or in combination with one or more of the first through eighth aspects, the threshold is further based at least in part on at least one of a minimum elevation angle of the serving cell or a rate of change of the elevation angle.

In a tenth aspect, alone or in combination with one or more of the first through ninth aspects, method 700 includes receiving fourth information indicating the minimum elevation angle.

In an eleventh aspect, alone or in combination with one or more of the first through tenth aspects, the first information includes the third information.

In a twelfth aspect, alone or in combination with one or more of the first through eleventh aspects, receiving the first information further comprises receiving the first information via system information for a serving cell, wherein the third information indicates the specified set of cell reselection parameters for the serving cell.

In a thirteenth aspect, alone or in combination with one or more of the first through twelfth aspects, the first information further indicates at least one of a reference speed or a reference altitude, and wherein the method further comprises identifying the specified set of cell reselection parameters according to the third information and based at least in part on a threshold, associated with the reference speed or the reference altitude, being satisfied.

In a fourteenth aspect, alone or in combination with one or more of the first through thirteenth aspects, method 700 includes transmitting capability information indicating whether the UE supports one or more of the first set of cell reselection parameters or the second set of cell reselection parameters.

In a fifteenth aspect, alone or in combination with one or more of the first through fourteenth aspects, the second set of cell reselection parameters is associated with air-to-ground cells.

In a sixteenth aspect, alone or in combination with one or more of the first through fifteenth aspects, selecting the specified set of cell reselection parameters further comprises selecting the particular set of cell reselection parameters as the specified set of cell reselection parameters.

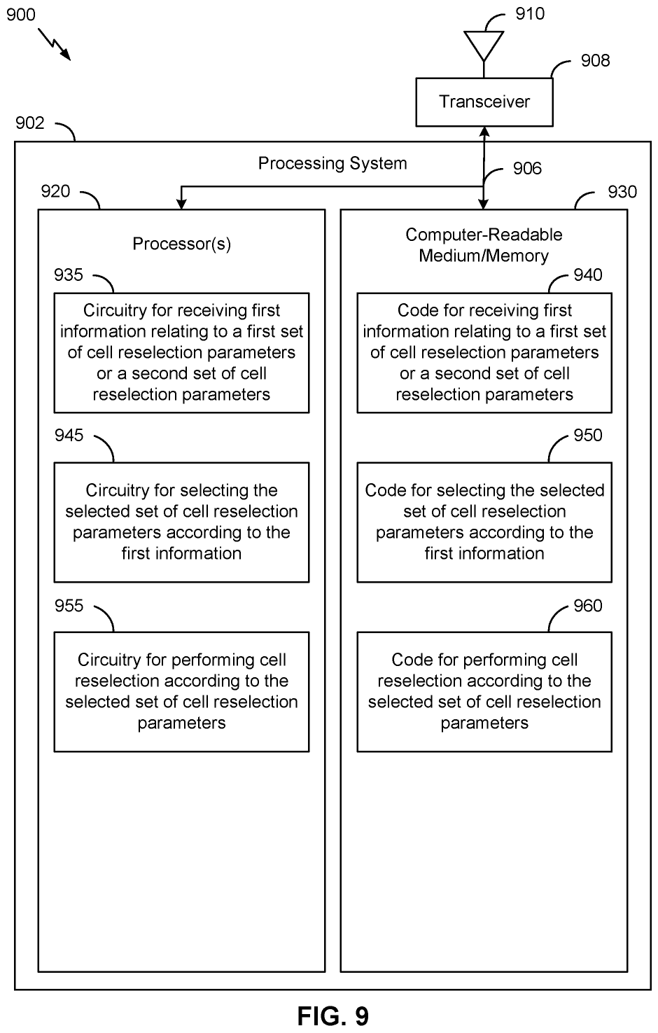

In one aspect, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative steps are possible consistent with this disclosure. For example, the UE may perform cell reselection according to the selected set of cell reselection parameters without explicitly selecting the set of cell reselection parameters (e.g., the UE may perform the cell reselection according to the selected set of cell reselection parameters in accordance with signaling indicating the selected set of cell reselection parameters).

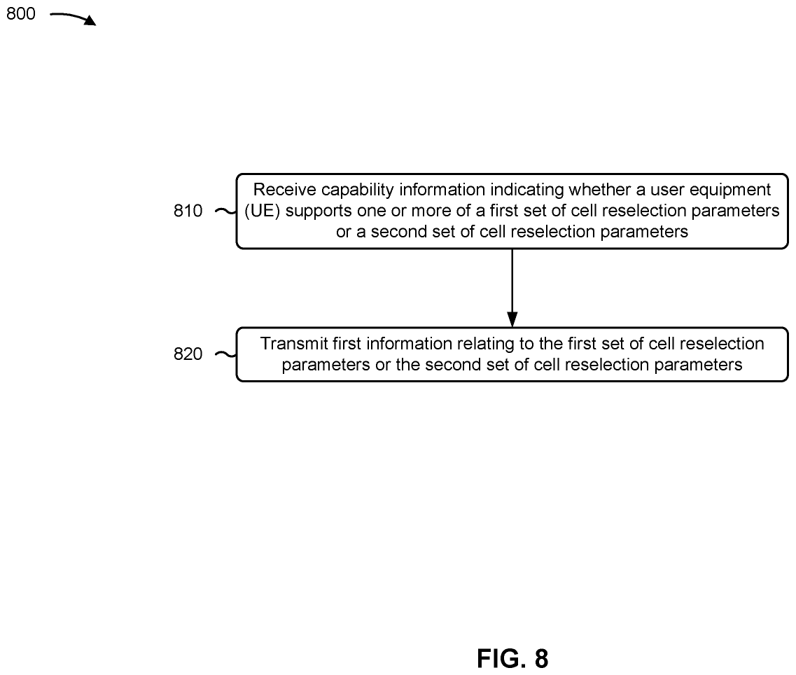

FIG. 8 shows a method 800 for wireless communications by a network entity, such as BS 110, or a disaggregated base station as discussed with respect to FIG. 3, in accordance with aspects of the present disclosure.

Method 800 begins at 810 with receiving capability information indicating whether a UE supports one or more of a first set of cell reselection parameters or a second set of cell reselection parameters.

Method 800 then proceeds to step 820 with transmitting first information relating to the first set of cell reselection parameters or the second set of cell reselection parameters. The first information may include at least one of second information indicating a location of one or more network entities, or third information indicating a particular set of cell reselection parameters. The particular set of cell reselection parameters may be the first set of cell reselection parameters or the second set of cell reselection parameters, and may be associated with air-to-ground (ATG) cells.

In a first aspect, the first information includes the second information.

In a second aspect, alone or in combination with the first aspect, method 800 includes transmitting fourth information indicating a threshold for the second information.

In a third aspect, alone or in combination with one or more of the first and second aspects, the threshold is a threshold serving cell size of a serving cell of the UE.

In a fourth aspect, alone or in combination with one or more of the first through third aspects, the threshold is further based at least in part on at least one of a speed of the UE, a dwell time of the UE, an altitude of the UE, or a distance from a reference point to a cell boundary of the serving cell of the UE.

In a fifth aspect, alone or in combination with one or more of the first through fourth aspects, method 800 includes transmitting fourth information indicating the threshold.

In a sixth aspect, alone or in combination with one or more of the first through fifth aspects, the threshold is based at least in part on an elevation angle between the UE and a serving cell of the UE.

In a seventh aspect, alone or in combination with one or more of the first through sixth aspects, the threshold is further based at least in part on at least one of a minimum elevation angle of the serving cell or a rate of change of the elevation angle.

In an eighth aspect, alone or in combination with one or more of the first through seventh aspects, method 800 includes transmitting fourth information indicating the minimum elevation angle.

In a ninth aspect, alone or in combination with one or more of the first through eighth aspects, the first information includes the third information.

In a tenth aspect, alone or in combination with one or more of the first through ninth aspects, transmitting the first information further comprises transmitting the first information via system information for a serving cell, wherein the third information indicates the selected set of cell reselection parameters for the serving cell.

In an eleventh aspect, alone or in combination with one or more of the first through tenth aspects, the first information further indicates at least one of a reference speed or a reference altitude.

In a twelfth aspect, alone or in combination with one or more of the first through eleventh aspects, the second set of cell reselection parameters is associated with air-to-ground cells.

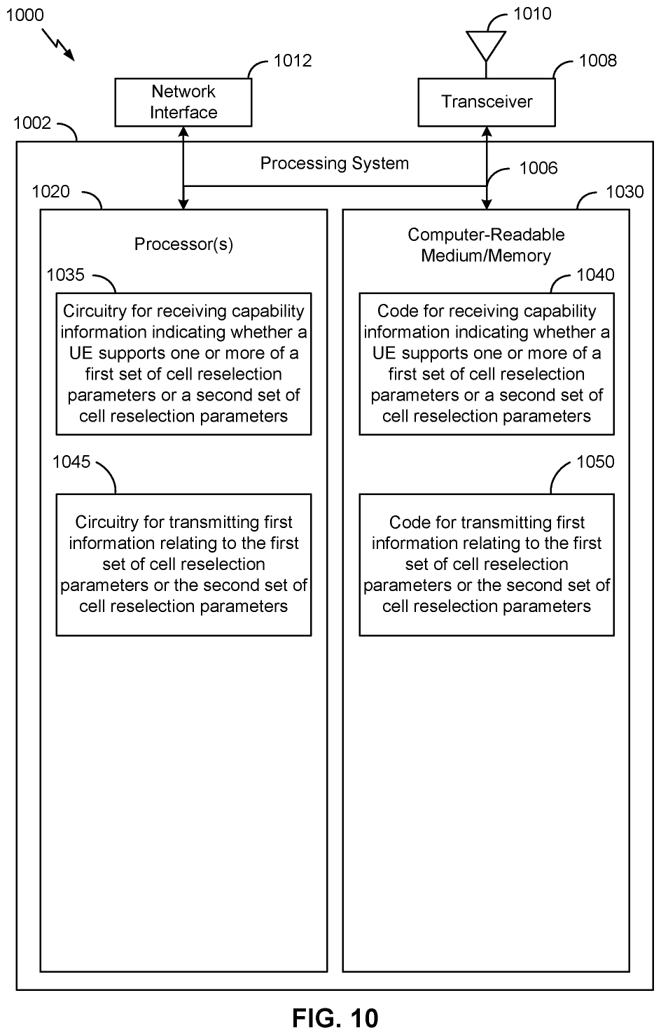

In one aspect, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative steps are possible consistent with this disclosure.

FIG. 9 is a diagram illustrating an example of an implementation of code and circuitry for a communications device 900, in accordance with aspects of the present disclosure. The communications device 900 may be a UE, or a UE may include the communications device 900.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of one or more of receive processor 258, transmit processor 264, TX MIMO processor 266, and/or controller/processor 280, as described with respect to FIG. 2. The one or more processors 920 are coupled to a computer-readable medium/memory 930 via a bus 906. In various aspects, the computer-readable medium/memory 930 may be representative of memory 282, as described with respect to FIG. 2. In certain aspects, the computer-readable medium/memory 930 is configured to store instructions (e.g., computer-executable code, processor-executable code) that when executed by the one or more processors 920, cause the one or more processors 920 to perform the method 700 described with respect to FIG. 7, or any aspect related to it. Note that reference to a processor performing a function of communications device 900 may include one or more processors performing that function of communications device 900.

As shown in FIG. 9, the communications device 900 may include circuitry for receiving first information relating to a first set of cell reselection parameters or a second set of cell reselection parameters (circuitry 935).

As shown in FIG. 9, the communications device 900 may include, stored in computer-readable medium/memory 930, code for receiving first information relating to a first set of cell reselection parameters or a second set of cell reselection parameters (code 940).

As shown in FIG. 9, the communications device 900 may include circuitry for selecting the selected set of cell reselection parameters according to the first information (circuitry 945).

As shown in FIG. 9, the communications device 900 may include, stored in computer-readable medium/memory 930, code for selecting the selected set of cell reselection parameters according to the first information (code 950).

As shown in FIG. 9, the communications device 900 may include circuitry for performing cell reselection according to the selected set of cell reselection parameters (circuitry 955).

As shown in FIG. 9, the communications device 900 may include, stored in computer-readable medium/memory 930, code for performing cell reselection according to the selected set of cell reselection parameters (code 960).

Various components of the communications device 900 may provide means for performing the method 700 described with respect to FIG. 7, or any aspect related to it. For example, means for transmitting, sending, or outputting for transmission may include the transceiver(s) 254 and/or antenna(s) 252 of the UE 120 and/or transceiver 908 and antenna 910 of the communications device 900 in FIG. 9. Means for receiving or obtaining may include the transceiver(s) 254 and/or antenna(s) 252 of the UE 120 and/or transceiver 908 and antenna 910 of the communications device 900 in FIG. 9.

FIG. 9 is provided as an example. Other examples may differ from what is described in connection with FIG. 9.

FIG. 10 is a diagram illustrating an example of an implementation of code and circuitry for a communications device 1000, in accordance with aspects of the present disclosure. The communications device 1000 may be a network entity (such as BS 110 or a disaggregated base station as described with regard to FIG. 3), or a network entity may include the communications device 1000.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals as described herein. The network interface 1012 is configured to obtain and send signals for the communications device 1000 via communications link(s), such as a backhaul link, midhaul link, and/or fronthaul link as described herein, such as with respect to FIG. 3. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of one or more of receive processor 238, transmit processor 220, TX MIMO processor 230, and/or controller/processor 240, as described with respect to FIG. 2. The one or more processors 1020 are coupled to a computer-readable medium/memory 1030 via a bus 1006. In various aspects, the computer-readable medium/memory 1030 may be representative of memory 242, as described with respect to FIG. 2. In certain aspects, the computer-readable medium/memory 1030 is configured to store instructions (e.g., computer-executable code, processor-executable code) that when executed by the one or more processors 1020, cause the one or more processors 1020 to perform the method 800 described with respect to FIG. 8, or any aspect related to it. Note that reference to a processor performing a function of communications device 1000 may include one or more processors performing that function of communications device 1000.

As shown in FIG. 10, the communications device 1000 may include circuitry for receiving capability information indicating whether a UE supports one or more of a first set of cell reselection parameters or a second set of cell reselection parameters (circuitry 1035).

As shown in FIG. 10, the communications device 1000 may include, stored in computer-readable medium/memory 1030, code for receiving capability information indicating whether a UE supports one or more of a first set of cell reselection parameters or a second set of cell reselection parameters (code 1040).

As shown in FIG. 10, the communications device 1000 may include circuitry for transmitting first information relating to the first set of cell reselection parameters or the second set of cell reselection parameters (circuitry 1045).

As shown in FIG. 10, the communications device 1000 may include, stored in computer-readable medium/memory 1030, code for transmitting first information relating to the first set of cell reselection parameters or the second set of cell reselection parameters (code 1050).

Various components of the communications device 1000 may provide means for performing the method 800 described with respect to FIG. 8, or any aspect related to it. For example, means for transmitting, sending, or outputting for transmission may include the transceiver(s) 232 and/or antenna(s) 234 of the BS 110 and/or transceiver 1008 and antenna 1010 of the communications device 1000 in FIG. 10. Means for receiving or obtaining may include the transceiver(s) 232 and/or antenna(s) 234 of the BS 110 and/or transceiver 1008 and antenna 1010 of the communications device 1000 in FIG. 10.

FIG. 10 is provided as an example. Other examples may differ from what is described in connection with FIG. 10.

The following provides an overview of some Aspects of the present disclosure:
Aspect 1: A method of wireless communication performed by a user equipment (UE), comprising: receiving first information relating to a first set of cell reselection parameters or a second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations; and performing cell reselection in association with the location of the one or more network entities or the particular set of cell reselection parameters.
Aspect 2: The method of Aspect 1, wherein the first information comprises the second information.
Aspect 3: The method of Aspect 2, comprising selecting the first set of cell reselection parameters or the second set of cell reselection parameters as the particular set of cell reselection parameters in accordance with a threshold and wherein performing cell reselection comprises performing cell reselection in association with the location of the one or more network entities.
Aspect 4: The method of Aspect 3, wherein the threshold is a threshold serving cell size of a serving cell of the apparatus.
Aspect 5: The method of Aspect 4, further comprising determining a serving cell size in accordance with the second information, wherein selecting the first set of cell reselection parameters or the second set of cell reselection parameters as the particular set of cell reselection parameters in accordance with the threshold further comprises selecting the particular set of cell reselection parameters by comparing the serving cell size and the threshold serving cell size.
Aspect 6: The method of Aspect 4, wherein the threshold is based at least in part on at least one of: a dwell time of the apparatus, an altitude of the apparatus, or a distance from a reference point to a cell boundary of the serving cell of the apparatus.
Aspect 7: The method of Aspect 3, comprising receiving fourth information indicating the threshold.
Aspect 8: The method of Aspect 3, wherein the threshold is based at least in part on an elevation angle between the apparatus and a serving cell of the apparatus.
Aspect 9: The method of Aspect 8, comprising determining the elevation angle between the apparatus and the serving cell in accordance with the second information.
Aspect 10: The method of Aspect 8, wherein the threshold is further based at least in part on at least one of a minimum elevation angle of the serving cell or a rate of change of the elevation angle between the apparatus and the serving cell.
Aspect 11: The method of Aspect 10, comprising receiving fourth information indicating the minimum elevation angle of the serving cell.
Aspect 12: The method of any of Aspects 1-11, wherein the first information comprises the third information and performing cell reselection comprises performing cell reselection according to the particular set of cell reselection parameters.
Aspect 13: The method of Aspect 12, wherein receiving the first information comprises receiving the first information via system information for a serving cell of the UE, wherein the third information indicates the particular set of cell reselection parameters for the serving cell.
Aspect 14: The method of Aspect 12, wherein the first information indicates at least one of a reference speed or a reference altitude, and wherein the method further comprises selecting the particular set of cell reselection parameters according to the third information and based at least in part on a threshold that is associated with the reference speed or the reference altitude being satisfied.
Aspect 15: The method of any of Aspects 1-14, comprising transmitting capability information indicating whether the apparatus supports one or more of the first set of cell reselection parameters or the second set of cell reselection parameters.
Aspect 16: The method of any of Aspects 1-15, wherein the one or more time durations comprise at least one of a detection time duration, a measurement time duration, or an evaluation time duration.
Aspect 17: A method of wireless communication performed by a network entity, comprising: receiving capability information indicating whether a user equipment (UE) supports one or more of a first set of cell reselection parameters or a second set of cell reselection parameters; and transmitting first information relating to the first set of cell reselection parameters or the second set of cell reselection parameters, the first information indicating at least one of second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations.
Aspect 18: The method of Aspect 17, wherein the first information comprises the second information.
Aspect 19: The method of Aspect 18, comprising transmitting fourth information indicating a threshold for the second information.
Aspect 20: The method of Aspect 19, wherein the threshold is a threshold serving cell size of a serving cell of the UE.
Aspect 21: The method of Aspect 19, wherein the threshold is based at least in part on at least one of: a dwell time of the UE, an altitude of the UE, or a distance from a reference point to a cell boundary of a serving cell of the UE.
Aspect 22: The method of Aspect 19, wherein the threshold is based at least in part on an elevation angle between the UE and a serving cell of the UE.
Aspect 23: The method of Aspect 22, wherein the threshold is further based at least in part on at least one of a minimum elevation angle of the serving cell or a rate of change of the elevation angle between the UE and the serving cell of the UE.
Aspect 24: The method of Aspect 23, comprising transmitting fourth information indicating the minimum elevation angle of the serving cell.
Aspect 25: The method of any of Aspects 17-24, wherein the first information comprises the third information.
Aspect 26: The method of Aspect 25, wherein transmitting the first information comprises transmitting the first information via system information for a serving cell of the UE, wherein the third information indicates a specified set of cell reselection parameters for the serving cell.
Aspect 27: The method of Aspect 25, wherein the first information further indicates at least one of a reference speed or a reference altitude.
Aspect 28: The method of any of Aspects 17-27, wherein the one or more time durations comprise at least one of a detection time duration, a measurement time duration, or an evaluation time duration.
Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-28.
Aspect 30: An apparatus for wireless communication at a device, the apparatus comprising one or more memories and one or more processors coupled to the one or more memories, the one or more processors configured to cause the device to perform the method of one or more of Aspects 1-28.
Aspect 31: An apparatus for wireless communication, the apparatus comprising at least one means for performing the method of one or more of Aspects 1-28.

Aspect 32: A non-transitory computer-readable medium storing code for wireless communication, the code comprising instructions executable by one or more processors to perform the method of one or more of Aspects 1-28.
Aspect 33: A non-transitory computer-readable medium storing a set of instructions for wireless communication, the set of instructions comprising one or more instructions that, when executed by one or more processors of a device, cause the device to perform the method of one or more of Aspects 1-28.
Aspect 34: A device for wireless communication, the device comprising a processing system that includes one or more processors and one or more memories coupled with the one or more processors, the processing system configured to cause the device to perform the method of one or more of Aspects 1-28.
Aspect 35: An apparatus for wireless communication at a device, the apparatus comprising one or more memories and one or more processors coupled to the one or more memories, the one or more processors individually or collectively configured to cause the device to perform the method of one or more of Aspects 1-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication, comprising:
a memory; and
one or more processors coupled to the memory and configured to:
receive first information relating to a first set of cell reselection parameters or a second set of cell reselection parameters, the first information indicating at least one of:
second information indicating a location of one or more network entities, or
third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations; and
perform cell reselection in association with the location of the one or more network entities or the particular set of cell reselection parameters.

2. The apparatus of claim 1, wherein the first information comprises the second information.

3. The apparatus of claim 2, wherein the one or more processors are configured to select the first set of cell reselection parameters or the second set of cell reselection parameters as the particular set of cell reselection parameters in accordance with a threshold and wherein performing cell reselection comprises performing cell reselection in association with the location of the one or more network entities.

4. The apparatus of claim 3, wherein the threshold is a threshold serving cell size of a serving cell of the apparatus.

5. The apparatus of claim 4, wherein the one or more processors are configured to determine a serving cell size in accordance with the second information, wherein the one or more processors, to select the first set of cell reselection parameters or the second set of cell reselection parameters as the particular set of cell reselection parameters in accordance with the threshold, are configured to select the particular set of cell reselection parameters by comparing the serving cell size and the threshold serving cell size.

6. The apparatus of claim 4, wherein the threshold is based at least in part on at least one of:
a dwell time of the apparatus,
an altitude of the apparatus, or
a distance from a reference point to a cell boundary of the serving cell of the apparatus.

7. The apparatus of claim 3, wherein the one or more processors are configured to receive fourth information indicating the threshold.

8. The apparatus of claim 3, wherein the threshold is based at least in part on an elevation angle between the apparatus and a serving cell of the apparatus.

9. The apparatus of claim 8, wherein the one or more processors are configured to determine the elevation angle between the apparatus and the serving cell in accordance with the second information.

10. The apparatus of claim 8, wherein the threshold is further based at least in part on at least one of a minimum elevation angle of the serving cell or a rate of change of the elevation angle between the apparatus and the serving cell.

11. The apparatus of claim 10, wherein the one or more processors are configured to receive fourth information indicating the minimum elevation angle of the serving cell.

12. The apparatus of claim 1, wherein the first information comprises the third information and the one or more processors, to perform cell reselection, are configured to perform cell reselection according to the particular set of cell reselection parameters.

13. The apparatus of claim 12, wherein the one or more processors, to receive the first information, are configured to receive the first information via system information for a serving cell of the apparatus, and wherein the third information indicates the particular set of cell reselection parameters for the serving cell.

14. The apparatus of claim 12, wherein the first information indicates at least one of a reference speed or a reference altitude, and wherein the one or more processors are configured to select the particular set of cell reselection parameters according to the third information and based at least in part on a threshold that is associated with the reference speed or the reference altitude being satisfied.

15. The apparatus of claim 1, wherein the one or more processors are configured to transmit capability information indicating whether the apparatus supports one or more of the first set of cell reselection parameters or the second set of cell reselection parameters.

16. The apparatus of claim 1, wherein the one or more time durations comprise at least one of a detection time duration, a measurement time duration, or an evaluation time duration.

17. An apparatus for wireless communication, comprising:
a memory; and
one or more processors coupled to the memory and configured to:
receive capability information indicating whether a user equipment (UE) supports one or more of a first set of cell reselection parameters or a second set of cell reselection parameters; and
transmit first information relating to the first set of cell reselection parameters or the second set of cell reselection parameters, the first information indicating at least one of:
second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations.

18. The apparatus of claim 17, wherein the first information comprises the second information.

19. The apparatus of claim 18, wherein the one or more processors are configured to transmit fourth information indicating a threshold for the second information.

20. The apparatus of claim 19, wherein the threshold is a threshold serving cell size of a serving cell of the UE.

21. The apparatus of claim 19, wherein the threshold is based at least in part on at least one of:
a dwell time of the UE,
an altitude of the UE, or
a distance from a reference point to a cell boundary of a serving cell of the UE.

22. The apparatus of claim 19, wherein the threshold is based at least in part on an elevation angle between the UE and a serving cell of the UE.

23. The apparatus of claim 22, wherein the threshold is further based at least in part on at least one of a minimum elevation angle of the serving cell or a rate of change of the elevation angle between the UE and the serving cell of the UE.

24. The apparatus of claim 23, wherein the one or more processors are configured to transmit fourth information indicating the minimum elevation angle of the serving cell.

25. The apparatus of claim 17, wherein the first information comprises the third information.

26. The apparatus of claim 25, wherein the one or more processors, to transmit the first information, are configured to transmit the first information via system information for a serving cell of the UE, wherein the third information indicates a specified set of cell reselection parameters for the serving cell.

27. The apparatus of claim 25, wherein the first information further indicates at least one of a reference speed or a reference altitude.

28. The apparatus of claim 17, wherein the one or more time durations comprise at least one of a detection time duration, a measurement time duration, or an evaluation time duration.

29. A method of wireless communication performed by a user equipment (UE), comprising:
receiving first information relating to a first set of cell reselection parameters or a second set of cell reselection parameters, the first information indicating at least one of:
second information indicating a location of one or more network entities, or
third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations; and
performing cell reselection in association with the location of the one or more network entities or the particular set of cell reselection parameters.

30. A method of wireless communication performed by a network entity, comprising:
receiving capability information indicating whether a user equipment (UE) supports one or more of a first set of cell reselection parameters or a second set of cell reselection parameters; and
transmitting first information relating to the first set of cell reselection parameters or the second set of cell reselection parameters, the first information indicating at least one of:
second information indicating a location of one or more network entities, or third information indicating a particular set of cell reselection parameters associated with air-to-ground (ATG) cells, wherein the particular set of cell reselection parameters is the first set of cell reselection parameters or the second set of cell reselection parameters, and wherein the particular set of cell reselection parameters indicates one or more time durations.
